(19) United States
(12) Patent Application Publication
(10) Pub. No.: US 2026/0202366 A1
(43) Pub. Date: Jul. 16, 2026

(54) NMR ANALYSIS FOR DIRECT LITHIUM EXTRACTION

(71) Applicant: Schlumberger Technology Corporation, Sugar Land, TX (US)

(72) Inventors: Dominic Vincent PERRONI, Sugar Land, TX (US); Adam COLBOURNE, Cambridge (GB)

(21) Appl. No.: 19/139,351

(22) PCT Filed: Jan. 16, 2024
(86) PCT No.: PCT/US2024/011586

§ 371 Date: Jun. 15, 2025

Related U.S. Application Data
(60) Provisional application No. 63/480,027, filed on Jan. 16, 2023.

(51) Int. Cl. G01N 24/08; C22B 26/12

(52) U.S. Cl. CPC G01N 24/085; C22B 26/12

(57) ABSTRACT

Nuclear magnetic resonance is used to analyze lithium content in a lithium withdrawal material used in a lithium extraction process. Methods described herein provide performing a loading process that comprises withdrawing lithium ions from a lithium containing aqueous material using a withdrawal material; and during the loading process, using nuclear magnetic resonance to obtain a signal representing loading of withdrawn lithium ions in the withdrawal material.

### CROSS-REFERENCE TO RELATED APPLICATIONS

This patent application claims benefit of U.S. Provisional Patent Application Ser. No. 63/480,027 filed Jan. 16, 2023, which is entirely incorporated herein by reference.

### FIELD

This patent application describes systems and methods of lithium recovery. Specifically, methods and apparatus of extracting lithium from an aqueous stream are described herein.

### BACKGROUND

Lithium is a key element in energy storage. Electrical storage devices, such as batteries, supercapacitors, and other devices commonly use lithium to mediate the storage and release of chemical potential energy as electrical current. As demand for renewable, but non-transportable, energy sources such as solar and wind energy grows, demand for technologies to store energy generated using such sources also grows.

According to the United States Geological Survey, global reserves of lithium total 22 million tons (metric) of lithium content, with Chile, Australia, Argentina, and China accounting for about 85% of global reserves. U.S. Geological Survey, Mineral Commodity Summaries, January 2022. According to S&P Global Market Intelligence, lithium supply is forecast to be 636 KT LCE in 2022, up from 497 kT in 2021. Global consumption was estimated at 64 kT in 2021, putting current lithium supplies in deficit. Global consumption and is expected to reach 2 MTa by 2030 for an average annual growth in demand of approximately 13.5%. Supply is currently forecast to run behind demand, and lithium prices currently outstrip even the most optimistic forecasts. While lithium prices are quite volatile as the global market develops, lithium prices are expected to remain high through 2030. The incentive for more lithium production could not be clearer.

Lithium can be extracted from aqueous streams by sorption processes in which lithium is adsorbed or absorbed from the aqueous stream into a medium and then removed from the medium relatively free of contaminants, resulting in isolation of the lithium from the original aqueous material. The medium is usually a solid material with a composition that makes the material selectively adsorb or absorb lithium. The lithium-bearing aqueous stream is contacted with the medium, which withdraws lithium from the aqueous stream. When the medium reaches a saturation point, an eluate is flowed through the medium to remove the lithium from the medium. As the cycle is repeated, the structure of the medium changes in a way that reduces loading capacity of the medium over time. The medium can be regenerated to restore some or all of its original loading capacity. Simple effective ways to analyze lithium extraction media to quantify the magnitude of degradation of the medium are needed.

### SUMMARY

Embodiments described herein provide a method, comprising extracting lithium from an aqueous material using a lithium selective extraction medium; and determining lithium content of the lithium selective extraction medium by nuclear magnetic resonance.

Other embodiments described herein provide a method, comprising disposing an extractor comprising a withdrawal medium within the magnetic field region of a nuclear magnetic resonance machine; contacting a lithium containing aqueous material with the withdrawal material to withdraw lithium ions from the aqueous material into the withdrawal material in a loading process; and during the loading process, operating the nuclear magnetic resonance machine to determine a trend in loading of lithium ions in the withdrawal material.

Other embodiments described herein provide a method, comprising contacting a lithium containing aqueous material with a volume of a withdrawal material to withdraw lithium ions from the aqueous material into the withdrawal material in a loading process; during the loading process, sampling the withdrawal material and obtaining a signal representing loading of withdrawn lithium ions in the sample by nuclear magnetic resonance; and determining an end point of the loading process based on the signal.

Other embodiments described herein provide a method, comprising using a withdrawal material to withdraw lithium ions from an aqueous material in a loading process; using an eluent to remove lithium ions from the withdrawal material in an unloading process; and using nuclear magnetic resonance to monitor performance of the withdrawal material during the loading process, the unloading process, or both.

Other embodiments described herein provide a method of recovering lithium from an aqueous material, the method comprising withdrawing lithium ions from the aqueous material by contacting the aqueous material with a withdrawal medium in a continuous cyclic process to load the withdrawal medium with lithium ions; contacting the loaded withdrawal medium with an aqueous eluent to unload lithium ions from the withdrawal medium; and monitoring loading and unloading of the withdrawal medium using nuclear magnetic resonance analysis.

### BRIEF DESCRIPTION OF THE DRAWINGS

FIG. 1 is a flow diagram summarizing a method according to one embodiment.

FIGS. 2A and 2B are flow diagrams summarizing a method according to another embodiment.

### DETAILED DESCRIPTION

Lithium recovery processes involving direct extraction of lithium ions from an aqueous material are becoming widely used. A lithium containing aqueous material is contacted with a withdrawal material in a loading process that withdraws lithium ions from the aqueous material into the withdrawal material. The aqueous material, depleted of lithium, can be returned to the environment or routed to other purposes. The withdrawal material can be a lithium selective material that can be highly selective for lithium, such that lithium is withdrawn from the aqueous material and other ions such as sodium, calcium, and magnesium remain in the lithium depleted aqueous material. An example of a withdrawal material that can be used is an ion exchange resin treated with lithium aluminum hydroxide. Another example of withdrawal material includes a solvent or a ion exchange membrane or any other structure or material that is able to withdraw ions from an aqueous solution.

Lithium ions accumulate in the withdrawal material until a first end point is reached, which can be when the withdrawal material has no more capacity to withdraw lithium ions from the aqueous material, or another selected time before or after the withdrawal material reaches its capacity. When the first end point is reached, the loading process is usually discontinued, and an aqueous eluent is contacted with the withdrawal material to remove lithium ions from the withdrawal material in an unloading process. The lithium ions are recovered into the eluent to form a lithium extract, which can be processed further into usable lithium products such as lithium carbonate, lithium hydroxide, and other materials. The unloading process continues until a second end point is reached, which can be when no further recovery of lithium ions from the withdrawal material can be detected, or a selected time before or after lithium recovery is undetectable such as a predetermined time deemed to preserve operating effectiveness of the withdrawal material. When the second end point is reached, the unloading process is usually discontinued and withdrawal of lithium from the lithium containing aqueous material can be restarted in a new loading process. The cycle of loading and unloading can be repeated any number of times until a third end point is reached, which can be when the withdrawal material has little capacity for loading with lithium ions after an unloading process. At that time, or a selected time before or after the lithium withdrawal capacity of the withdrawal material is unrecoverable, the withdrawal material can be subjected to a regeneration process, which can involve exposing the withdrawal material to a cleaning material, such as a water or brine stream, or a lithium selective solvent, which can be performed at an elevated temperature.

Methods of detecting changes in lithium ion content of the withdrawal material can help in determining the various end points described above. Nuclear magnetic resonance can be used in a number of ways to detect and monitor lithium loading and unloading of a withdrawal medium. To determine lithium ion content of the withdrawal material, or to determine an end point in a lithium extraction process, a sample of the withdrawal material can be subjected to nuclear magnetic resonance (“NMR”) analysis. Methods of analyzing lithium content in various media are known. A sample of the withdrawal material can be obtained, or the withdrawal material can be analyzed in-situ without collecting a sample. If subjected to a well-controlled analysis, NMR methods can provide repeatable signals representing content of withdrawn lithium in the withdrawal material, which can be used to determine the processing end points above. Such methods can also provide repeatable signals representing content of lithium in solution in the lithium containing aqueous material contacting the withdrawal material. In some cases, an NMR machine (e.g. the magnet of the NMR machine) can be disposed around, disposed within, or attached to a lithium withdrawal unit that includes withdrawal material so the withdrawal process can be operated within the NMR magnetic field region. In other cases, a reference unit configured to match an operational unit can be disposed within the NMR magnetic field region to provide analyses representing performance of the operational unit.

The methods described herein are applicable to continuous and semi-continuous direct lithium extraction processes involving continuous loading and unloading of withdrawal media, like that found in a continuous counter current adsorption desorption system or process. Such processes are known, for instance from Energy Source Minerals PCT Application WO2019/221932, and NMR analysis can be used to monitor progression of loading and unloading of withdrawal media and provide data for tuning such processes by adjusting, for example, cycle time of the withdrawal media, fluid temperature, flow rates, and volume of withdrawal medium in service, among other things. In one embodiment, multiple volumes of withdrawal medium are operated in various stages of loading and unloading with lithium ions (with for instance, a plurality of vessels, each containing a volume of withdrawal medium). The vessels are generally in series and a withdrawal medium contained in one vessels may be fully loaded while another is not. Each volume of withdrawal medium is contacted with an aqueous material bearing lithium ions, which are withdrawn into the withdrawal medium. The vessels are cyclically switching between different stations, the station being connected to different elements such as other stations and external fluid sources. When the withdrawal medium reaches a loading end point, the loaded withdrawal medium is contacted with an aqueous eluent to unload the lithium ions from the withdrawal medium. While one withdrawal medium volume is in an unloading phase, another withdrawal medium volume is in loading phase. Multiple such volumes can be used depending on needed lithium recovery capacity. A plurality of NMR analyses, as described herein, can be used to monitor progression of loading and unloading phases of some, possible each, of the volumes of withdrawal medium, and the process can be continuously tuned by adjusting cycle time (loading and unloading time) of one or more volumes of withdrawal medium, temperature of the aqueous material, temperature of the aqueous eluent, flow rate of the aqueous material, flow rate of the aqueous eluent, or volume of withdrawal material (for example number of volumes of withdrawal material) in service, or any combination thereof, based on the results of the NMR analyses.

The withdrawal material can be directly subjected to NMR analysis at a frequency matched to the Larmor frequency of lithium isotopes subjected to a magnetic field, such as ⁷Li, either by collecting a sample of withdrawal material or by in-situ NMR analysis of the withdrawal material. In other cases, a sample of the withdrawal material can be prepared in various ways, for example by drying so that the dry solid can be subjected to analysis, or by disposing the withdrawal material into a selected medium such as ammonia or D₂O. Such methods of ⁷Li NMR spectroscopic analysis, using, for example, a frequency of 155 MHz at field strength of 9.4 T, are known to yield chemical shifts of solvated lithium near 0 ppm and graphite intercalated lithium at 30 ppm.

Lithium can exist in a withdrawal material in both solution form, as lithium ions in an aqueous solution, or in a form associated with the solid withdrawal material. These two forms of lithium are distinguishable by ⁷Li NMR, which as noted above is known to return different signals for solution lithium and intercalated lithium, and can be used to distinguish a quantity of solvated lithium from a quantity of lithium withdrawn from solution into the withdrawal material. The specific chemical shift of the withdrawn lithium depends on the withdrawal material and the NMR analysis characteristics, but the chemical shift of the withdrawn lithium can be ascertained by exposing an unused volume of withdrawal material (having no lithium) to a solution of lithium chloride to withdraw lithium into the withdrawal material, and then conducting ⁷Li NMR analysis of the withdrawal material. Where the withdrawal material still contains some lithium-containing solution, two or more signals are obtained at different chemical shifts, the reference chemical shift of solution lithium conventionally being calibrated to 0 ppm, and the withdrawn lithium having chemical shift where the second NMR signal is observed. The size (i.e. integrated area) of each of the two NMR signals (for solvated lithium and lithium associated with the withdrawal material) indicates relative quantity of lithium atoms in the two states. For example, if the integrated area of the signal calibrated to 0 ppm is twice the magnitude of the integrated area of the chemically shifted signal (representing withdrawn lithium), number of lithium atoms in the analyzed volume in the solution state can be understood to be twice the number of lithium atoms in the withdrawn state. If the mass of the withdrawal material in the sample is known, and the quantity and lithium concentration (by mass or volume) of the lithium chloride solution is known, the integrated areas of the two NMR signals can be used to determine concentration of lithium in the withdrawal medium, and the concentration can be related to the peak areas to define a calibration curve. Such methods can be performed using an in-situ NMR analysis configuration or by sampling.

A known quantity of a withdrawal material can be exposed to a known quantity of a standard lithium solution to calibrate an NMR analysis for lithium in the withdrawal material. NMR analysis of the lithium-exposed withdrawal material test volume can be performed at a predetermined exposure time to obtain one or more signals, such as a first signal representing lithium atoms in solution and a second signal representing lithium atoms withdrawn from solution into the lithium-exposed withdrawal medium. The one or more signals, for example a magnitude of the first and second signals, can be used to determine a quantity of lithium withdrawn into the withdrawal material at the exposure time. Multiple NMR analyses can be performed on the lithium-exposed test volume of withdrawal material at different predetermined times to define a loading profile of the withdrawal material and/or to define a relation between the first signal, the second signal, and the quantity of withdrawn lithium. Multiple lots of withdrawal material can be tested in this way, using different standard lithium solutions, to improve confidence in the relation.

In a similar manner, the different spin-lattice or spin-spin relaxation time constants for solvated and intercalated lithium can be exploited. Known NMR relaxometry methods can be applied to generate NMR signals that decay in amplitude at a rate determined by the aforementioned time-constants. These signal decays can be fitted to a combination of exponential functions, which can be evaluated at zero-time to give a concentration. Alternatively, the acquired signal decays can be numerically inverted using known techniques to provide peaks separated on the basis of spin-spin and/or spin-lattice time constants. These peaks can then be integrated to give the concentration of lithium solvated by the aqueous material and the concentration of lithium in the withdrawal medium separately. Additionally, the shape and position of the peak associated with the intercalated lithium can be analyzed to yield information on pore space of the withdrawal material or to determine whether a regeneration end point has been reached. If, for example, in a particular withdrawal material, immovable lithium is held in the withdrawal material in a different manner than extractable lithium, these may appear as separate signals in relaxometric data. Such separate, or partially resolved signals may be quantified to assess the need to regenerate the withdrawal material, or the remaining life of a batch of withdrawal material.

As noted above, a sample can be withdrawn from the withdrawal material, or the vessel containing the withdrawal material can be operated within the excitation/detection coil of the NMR machine. Where the withdrawal material is housed in a conductive container, the conductive container can be used as part of a resonant circuit to provide the radio frequency (“RF”) magnetic field (conventionally “B₁”) used to stimulate an NMR signal within the withdrawal material. An internal conductor can be disposed within the withdrawal material to provide electromagnetic coupling between the internal conductor and the vessel wall that can be used to project B₁ into the withdrawal material and return the detected NMR signal via capacitive coupling.

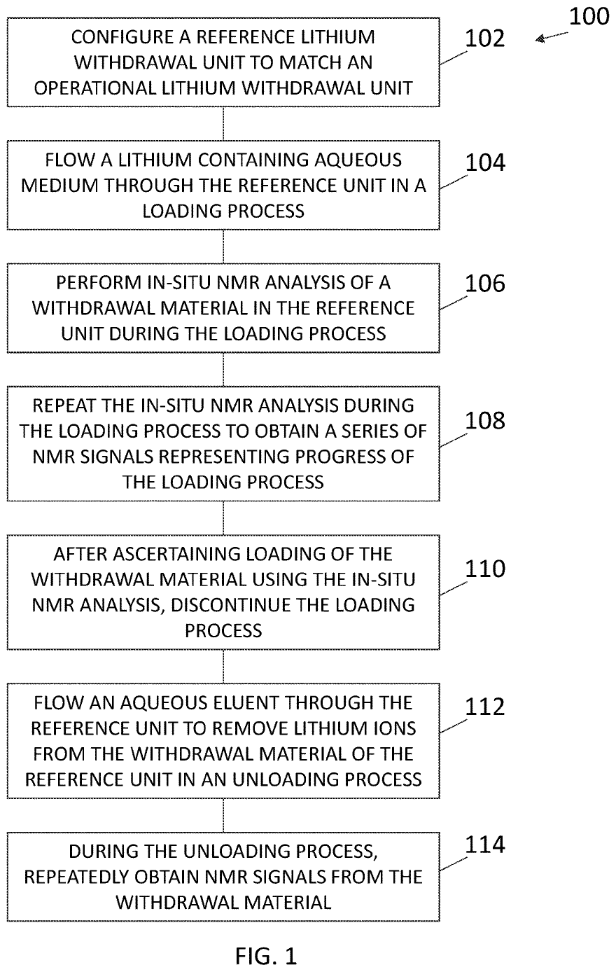

FIG. 1 is a flow diagram summarizing a method 100 according to one embodiment. The method 100 can be used to derive characteristics of a lithium withdrawal unit used to withdraw lithium ions from a lithium containing aqueous material. At 102, a reference withdrawal unit is configured to match an operational withdrawal unit. The operational withdrawal unit is used as part of a lithium recovery process to withdraw lithium from a lithium containing aqueous material in preparation for producing a lithium product, such as lithium hydroxide or lithium carbonate, which can be used for commercial manufacturing. The reference unit is used to ascertain operating characteristics that can be used to predict performance of the operational unit. Each of the reference unit and the operational unit are configured to contact a withdrawal material with a lithium containing aqueous material. The reference unit is normally configured to be smaller than the operational unit for convenience, but is geometrically equivalent to the operational unit, for example in such parameters as ratio of length to diameter and ratio of withdrawal material particle size to diameter. The reference unit is configured to support in-situ NMR analysis of the withdrawal material inside, so the reference unit is made of a material that does not block or distort RF magnetic fields. The reference unit is located within the magnetic field region of an NMR machine configured to conduct ⁷Li analysis so that NMR analysis of the withdrawal material can be performed in-situ without removing samples of the material.

At 104, a lithium containing aqueous material is flowed through the reference unit to contact the lithium containing aqueous material with the withdrawal material in a loading process. As noted above, the withdrawal material withdraws lithium ions from the lithium containing aqueous material into the withdrawal material in an absorption or intercalation process, thus changing the electronic properties of the withdrawn lithium ions. Flow rate of the lithium containing aqueous material to the reference unit is scaled to match the geometry of the operational unit.

At 106, in-situ NMR analysis of the withdrawal material in the reference unit is performed during the loading process. Calibration of the chemical shifts of solution lithium and withdrawn lithium can be previously determined by loading a new withdrawal material into the reference extractor, exposing the new withdrawal material to a solution of lithium chloride, and performing NMR analysis (in-situ or ex-situ) of the new withdrawal material. With a well-controlled and calibrated NMR machine, the in-situ analysis results in two peaks, one for solution lithium and another for withdrawn lithium. The chemical shifts and amplitudes of these peaks can then be used for the in-situ analysis of the reference unit.

At 108, during the loading process, in-situ NMR analysis of the withdrawal material can be repeated to yield a time-series of NMR signals representing progress of the loading process. Change in the size (i.e. integrated area) of the signals can be used to represent progressive loading of the withdrawal material with lithium ions. When growth of the NMR signal associated with withdrawn lithium stops, it can be surmised that withdrawal of lithium ions from the lithium containing aqueous material has stopped, for example because the withdrawal material has reached its loading capacity. The loading profile and limits of the withdrawal material in the reference unit ascertained by NMR can be used to predict performance of the operational unit.

At 110, after ascertaining a loading of the withdrawal material using the in-situ NMR analysis of 106 and 108, the loading process is discontinued. An end point of the loading process can be selected at a time before or after growth of the withdrawn lithium NMR signal stops, and may be based on comparing the withdrawn lithium NMR signal to any suitable reference. Such references may include, or be based on, previous NMR results, results obtained using other withdrawal materials, results from other withdrawal units, and physical models incorporating such results.

At 112, an aqueous eluent stream is flowed through the reference unit to remove lithium ions from the withdrawal material. The aqueous eluent stream is typically the same as, or as close as possible to, the aqueous eluent used to remove lithium ions from the withdrawal material in the operational unit. The flow rate of the aqueous eluent can be scaled to match the geometry of the operational unit.

At 114, while flowing the aqueous eluent through the reference unit, in-situ NMR analysis of the withdrawal material in the reference unit can be repeatedly performed to yield a time-series of NMR results during unloading of the withdrawal material. When the NMR signals of the withdrawn lithium stop changing, it can be surmised that removal of lithium ions from the withdrawal material has stopped, for example because the withdrawal material has reached a minimum of withdrawn lithium, beyond which no more lithium can be removed.

Results of the in-situ NMR analysis of the withdrawal material of the reference unit can be used to predict performance of the operational unit. One reference unit can be used to represent more than one operational unit so that the end points of a plurality of operational lithium withdrawal units can be predicted from analysis of the withdrawal material used for the operational units in one reference unit. NMR analysis using the reference unit can be repeated at convenient times, for example when a new lot of withdrawal material is to be installed in the operational units. Performance of one or more operational units can be tracked using a reference unit by flowing a mass-scaled quantity of lithium containing aqueous material through the reference unit to match utilization of the withdrawal material in the operational unit. Such methods can be used to obtain mid-cycle predictions about future performance of the operational units.

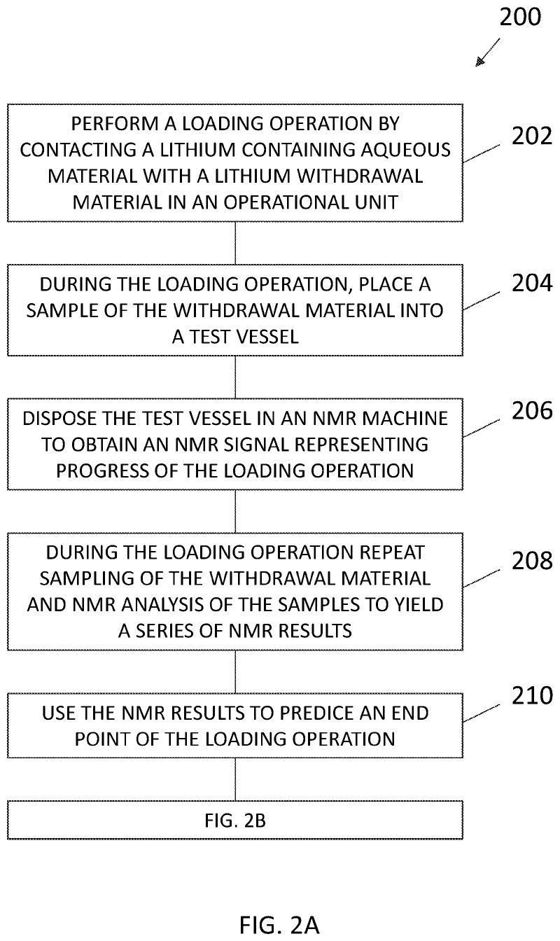

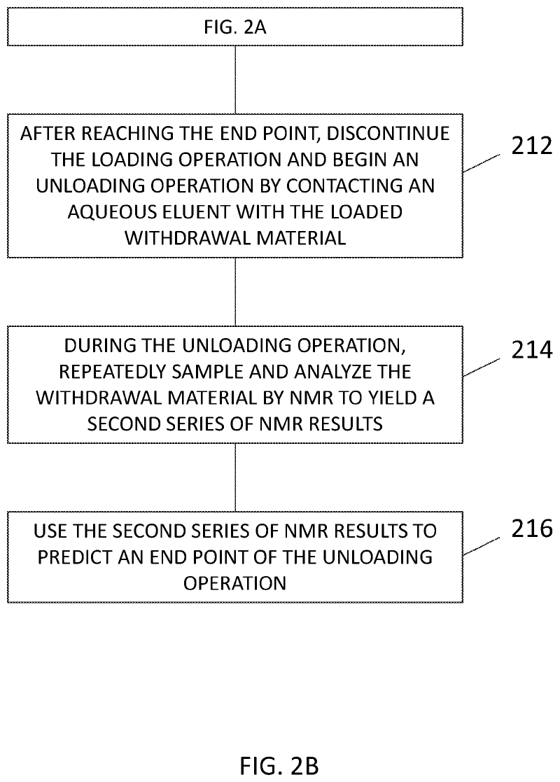

FIGS. 2A and 2B are flow diagrams summarizing a method 200 according to another embodiment. In the method 200, NMR analysis is performed using samples taken from a withdrawal material of an operational lithium extractor to determine end points. At 202, a lithium containing aqueous material is contacted with a withdrawal material in an operational unit to perform a loading operation.

At 204, during the loading operation, the withdrawal material is sampled by removing a small portion of the withdrawal material from the operational unit. The sample is disposed in a test vessel, such as a vial, to be used for analysis of the sample. Exposure of the sample to air need not be avoided, but is generally minimized between removal of the sample from the extractor and placement of the sample in the test vessel.

At 206, the test vessel containing the sample is disposed within an NMR machine for analysis. NMR signals from the analysis are used to represent a quantity of aqueous lithium and a quantity of withdrawn lithium in the sample.

At 208, while contacting the lithium containing aqueous material with the withdrawal material, sampling and NMR analysis of the withdrawal material is repeated to yield a time-series of NMR results.

At 210, the NMR results are used to predict or determine an end point of the loading operation. A single NMR result, or a time-series of NMR results, can reflect an end point that is based on quantity of lithium ions in the withdrawal material, change in quantity of lithium ions in the withdrawal material, quantity of lithium ions in the aqueous material at selected locations within the withdrawal material (for example at a middle location or near a fluid exit location), change in quantity of lithium ions in the aqueous material at selected locations with the withdrawal material, a difference between quantity of lithium ions in the withdrawal material and quantity of lithium ions in the aqueous material, change in the different between quantity of lithium ions in the withdrawal material and quantity of lithium ions in the aqueous material, or any combination or derivative of any such parameters.

At 212, after determining that the end point has been reached, the loading operation is discontinued and an aqueous eluent is contacted with the loaded withdrawal material to remove lithium ions from the withdrawal material in an unloading operation.

At 214, while contacting the aqueous eluent with the withdrawal material, the repeatedly sampled and subjected to NMR analysis to yield a second time-series of NMR results.

At 216, the second NMR results are used to predict an end point of the unloading operation. The endpoint can be recognized by determining that successive NMR results for withdrawn lithium are not changing or by determining that a mass transport driving force for unloading lithium from the withdrawal material does not exist using the quantities of lithium ascertained in solution and withdrawn forms. Upon determining that the end point has been reached, the unloading operation can be discontinued.

The method 200 can be repeated in cycles, loading and unloading the withdrawal material to recover lithium from the lithium containing aqueous material. As NMR results are collected in the various cycles, the NMR results from one cycle can be compared to the NMR results from other cycles. For example, total loading of lithium ions into the withdrawal material can be compared from cycle to cycle. Total loading of lithium ions in one cycle is the difference between the first NMR result in a loading operation and the last NMR result in the same loading operation. That loading of lithium ions can be compared between cycles to understand how the loading capacity of the withdrawal material changes from cycle to cycle. As the withdrawal material is loaded and unloaded, capacity of the withdrawal material to absorb lithium ions diminishes. By comparing lithium loading from cycle to cycle, capacity of the withdrawal material can be predicted for future cycles, and a time can be predicted and/or selected at which the withdrawal material needs to be regenerated or replaced with new withdrawal material.

In addition to monitoring a loading process of a lithium withdrawal material, ascertaining an end point of a loading process, and ascertaining a regeneration point of a lithium withdrawal material, NMR results can also be compared between cycles separated by a regeneration process. Capacity of the withdrawal material to absorb lithium ions can be improved by performing a regeneration process, which typically includes exposing the withdrawal material to a hot fluid, such as hot water, alcohol, or lithium-selective solvents (e.g. formic acid, N-methylformamide, hydrazine, and/or tetrahydrofuran), or mixtures thereof. Regeneration of the lithium withdrawal material can remove lithium ions that cannot be removed efficiently by simple eluent contacting. Regeneration may also regenerate structures and/or compositions of the withdrawal material that are conducive to selective withdrawal of lithium from an aqueous material. Effectiveness of a regeneration process can be evaluated by comparing lithium loading in a cycle immediately prior to a regeneration process with lithium loading in a cycle immediately following the regeneration process. An increase in loading indicates lithium loading capacity has been recovered. Magnitude of the recovery can be compared with other regeneration processes to determine whether regeneration of the withdrawal material has been successful. Usually, over many regeneration cycles the effectiveness of a regeneration cycle declines. By comparing NMR results before and after successive regeneration cycles, loading capacity of a withdrawal material can be monitored. Change in loading capacity of the withdrawal material, from cycle to cycle or over a period of cycles, can be ascertained and monitored, and the change can indicate performance of the withdrawal material. By monitoring loading capacity over multiple regeneration cycles, an end point can be projected at which regeneration will no longer be effective to restore absorption capacity and new withdrawal material will be needed, indicating an exhaustion point of the withdrawal material. It is also thought that over many regeneration cycles the rate of decline in loading capacity with loading/unloading cycles accelerates. That is to say, it is thought that the decline in loading capacity from one loading cycle to the next is expected to be larger after many regeneration cycles than for a new withdrawal material. The decline in loading capacity over time can be evaluated by comparing loading results, from NMR analysis, at the same cycle point after regeneration cycles. For example, loading capacity of the third loading cycle after a regeneration can be compared over time to observe whether capacity at the third loading cycle is diminishing with successive regeneration processes.

Lithium analysis of withdrawal material by NMR can be useful in other ways. For example, the first loading of lithium into a withdrawal material can be compared from one lot of withdrawal material to the next. If the mass of the withdrawal material loaded into the extractor is known each time, lithium loading results for the two loads of withdrawal material can be normalized for mass of the withdrawal material, and the loading capacity can be compared, for example between a first withdrawal material and a second withdrawal material. If the first lithium loading cycle for a second withdrawal material is found to withdraw more lithium from the aqueous material than the first lithium loading cycle of a first withdrawal material, used prior to the second withdrawal material, it can be predicted that the second load of withdrawal material will withdraw more total lithium before completion than the first load. Depending on how the new withdrawal material performs, as shown by NMR analysis of lithium loading, the increased lithium withdrawal may manifest as more loading/unloading cycles between regenerations, more regenerations before completion, or just larger loading quantities for each loading/unloading cycle, or a combination thereof. Patterns in the NMR analysis data can reveal such trends and enable predictions about the performance of the withdrawal material.

Samples can also be analyzed from various locations in an operational extractor to ascertain gradients in lithium loading within the withdrawal material. For example, where contacting of the lithium containing aqueous material and the withdrawal material is directional a gradient, for example a loading gradient, an unloading gradient, or both, of lithium loading might be observed. The first withdrawal material to contact the lithium containing aqueous material might be expected to load with lithium faster than withdrawal material further along the column. In such cases, more than one sample of the withdrawal material taken at the same time might be expected to show different loading results. In an extractor configured such that lithium containing aqueous material flows directionally from inlet to outlet of the extractor, NMR results for withdrawn lithium in samples taken near the inlet and the outlet of the extractor might be expected to show different results. It would be expected that, during a lithium loading process, lithium loading in the sample taken near the extractor outlet would lag behind loading of the sample taken near the inlet.

In general, if multiple samples of withdrawal material are taken during a loading process from a column of withdrawal material directionally exposed to lithium containing aqueous material, NMR analysis of the samples will show a trend in withdrawn lithium content. The trend would be expected to be monotonic from samples taken near the inlet of the extractor to samples taken near the outlet. Characteristics of the trend could be used to predict performance of the extractor. Slope of the trend can indicate overall health of the withdrawal material. Progression of the trend over time can indicate approach of an end point in loading of the withdrawal material. For example, an inflection point of the trend can be computed from data points of the trend (withdrawn lithium concentration as a function of axial location of samples within the column of withdrawal material) by any convenient mathematical method. Location of the computed inflection point, for example percentage of the distance along the column of the withdrawal material, can be an alternate measure of lithium loading that can be more useful in some aspects. The inflection point can be computed by fitting a curve through the data points resulting from NMR analysis of the samples taken at different locations of the column of withdrawal material at the same time and finding an axial location of the column at which the second derivative of the trend curve is zero. The inflection point can also be defined, instead, as the location at which lithium loading falls to a predetermined fraction of the maximum in the trend. For example, the inflection point can be defined as the axial location of the column of withdrawal material at which a curve fit to lithium loading data points obtained by NMR analysis of samples taken, at the same time, from different axial locations of the column of withdrawal material declines to 25% of its maximum value.

Where lithium loading analysis is used to detect an end point in lithium ion loading of a withdrawal material, comparison of the withdrawn lithium signal to the solution lithium signal can be useful. In particular, if concentration of lithium ions in the lithium containing aqueous material is changing, it may affect withdrawal of those ions from the aqueous material into the withdrawal material. Thus, if rate of lithium loading is seen to decline, using NMR analysis, the solution lithium signals can be consulted to determine whether, and to what extent, the decline might be due to decline in overall concentration of lithium in the aqueous material versus decline in performance of the withdrawal material. In some cases, a ratio of the withdrawn lithium signal to the solution lithium signal can be interpreted as a measure of the rate of lithium withdrawal. Where the ratio is high, concentration of lithium ions in the aqueous material might not provide driving force sufficient to increase absorption of lithium ions by the withdrawal material. Conversely, where the ratio is low, driving force to withdraw lithium ions into the withdrawal material may be regarded as high. Ratio of the withdrawn lithium signal to the solution lithium signal, available in a single NMR analysis, can help distinguish variation in lithium concentration of the lithium containing aqueous material from performance of the withdrawal material.

Lithium concentration in the lithium containing aqueous material can be ascertained by calibrating the solution lithium NMR signal to known lithium solutions. Standard solutions of lithium chloride at known mass or molar concentrations can be subjected to ⁷Li analysis, and the peak areas obtained related to the concentrations to provide a calibration curve. The solution NMR signal from a sample of the withdrawal material can then be compared to the calibration curve to ascertain concentration of lithium ions in the lithium containing aqueous material.

Methods similar to those described herein to measure lithium content using nuclear magnetic resonance can also be used to measure the content of other elements of interest, such as manganese, nickel, cobalt, magnesium, iron, copper, zinc, vanadium, and molybdenum. Methods of using nuclear magnetic resonance to measure content of such elements in any suitable medium, such as aqueous solution or intercalated in a sorption medium, are known and can be used along with the methods described herein to resolve the content of various elements of interest in a sequential or concurrent manner. NMR data can be collected from a sample and used to resolve signals representing the content of lithium and other elements of interest. Alternately, multiple NMR scans can be taken for a single sample and used to resolve the content of lithium and other elements of interest. For example, analytical methods, such as integral transform methods, can be applied, repeatedly and sequentially, to the data from a single scan to resolve the content of multiple elements of interest from the data of a single scan. Alternately, repeated and sequential NMR scans of a single sample can be used to resolve the content of different elements of interest. Thus, in any of the methods described herein, the content of one or more elements of interest besides lithium can be resolved using sequential nuclear magnetic resonance analyses.

Methods are described herein that include performing a loading process that comprises withdrawing lithium ions from a lithium containing aqueous material using a withdrawal material and, during the loading process, using nuclear magnetic resonance to obtain a signal representing loading of withdrawn lithium ions in the withdrawal material. The method can also include determining an end point of the loading process based on the signal. The method can also include, upon reaching the end point of the loading process, discontinuing the loading process and beginning an unloading process that comprises contacting the withdrawal material with an aqueous eluent. In some cases, the signal can be a first signal, and the method can also include, during the unloading process, using nuclear magnetic resonance to obtain a second signal representing loading of withdrawn lithium ions in the withdrawal material. The method can also include determining an end point of the unloading process based on the second signal and discontinuing the unloading process when the end point is reached. The end point can be determined based on an integrated area of the second signal. The loading process can be a counter current adsorption desorption process. Nuclear magnetic resonance can be used herein to obtain a plurality of signals representing loading of withdrawn lithium ions in a plurality of volumes of the withdrawal material.

Methods are also described herein that include disposing an extractor comprising a withdrawal medium within a magnetic field region of a nuclear magnetic resonance machine, contacting a lithium containing aqueous material with the withdrawal material to withdraw lithium ions from the aqueous material into the withdrawal material in a loading process, and during the loading process, operating the nuclear magnetic resonance machine to determine a trend in loading of lithium ions in the withdrawal material. Operating the nuclear magnetic resonance machine can include establishing a relation of a signal of the nuclear magnetic resonance machine to a quantity of lithium withdrawn into the withdrawal material by exposing an unused volume of the withdrawal material to a standard lithium solution to yield a lithium-exposed withdrawal material test volume and performing nuclear magnetic resonance analysis of the test volume.

Methods are also described herein that include contacting a lithium containing aqueous material with a volume of a withdrawal material to withdraw lithium ions from the aqueous material into the withdrawal material in a loading process, during the loading process, sampling the withdrawal material and obtaining a signal representing loading of withdrawn lithium ions in the sample by nuclear magnetic resonance, and determining an end point of the loading process based on the signal. Sampling the withdrawal material can include obtaining a plurality of samples of the withdrawal material at different times, different locations in the volume of the withdrawal material, or both, obtaining a signal can include obtaining a signal representing loading of withdrawn lithium ions in each sample by nuclear magnetic resonance, and determining and end point of the loading process can include comparing the signals obtained from the plurality of samples.

Methods are also described herein that include using a withdrawal material to withdraw lithium ions from an aqueous material in a loading process, using an eluent to remove lithium ions from the withdrawal material in an unloading process, and using nuclear magnetic resonance to monitor performance of the withdrawal material during the loading process, the unloading process, or both. Using nuclear magnetic resonance to monitor performance of the withdrawal material can include ascertaining a loading capacity of the withdrawal material, ascertaining a change in loading capacity of the withdrawal material, ascertaining an end point of the loading process, ascertaining an end point of the unloading process, ascertaining a regeneration point of the withdrawal material, ascertaining an exhaustion point of the withdrawal material, ascertaining a lithium loading gradient of the withdrawal material, ascertaining a lithium unloading gradient of the withdrawal material, and comparing the performance of a first withdrawal material with a second withdrawal material. Using nuclear magnetic resonance to monitor performance of the withdrawal material can also include obtaining a nuclear magnetic resonance signal of lithium atoms in the withdrawal material and determining an integrated area of the signal. Using nuclear magnetic resonance to monitor performance of the withdrawal material can also include performing a plurality of nuclear magnetic resonance analyses of the withdrawal material at different times, different locations, or both. Using nuclear magnetic resonance to monitor performance of the withdrawal material can also include determining a relation between a nuclear magnetic resonance signal and a lithium quantity in the withdrawal material by exposing an unused volume of the withdrawal material to a standard lithium solution to yield a lithium-exposed withdrawal material test volume and performing nuclear magnetic resonance analysis on the test volume. The methods can also include adjusting a cycle time of the withdrawal material, temperature of the aqueous material, temperature of the eluent, flow rate of the aqueous material, flow rate of the eluent, volume of withdrawal material in service, or any combination thereof based on the nuclear magnetic resonance monitoring. Each of the loading process and the unloading process can be part of a counter current adsorption desorption process. Using nuclear magnetic resonance to monitor performance of the withdrawal material can include performing in-situ nuclear magnetic resonance analysis on the withdrawal material. Using nuclear magnetic resonance to monitor performance of the withdrawal material can also include performing in-situ nuclear magnetic resonance analysis on the withdrawal material.

Methods of recovering lithium from an aqueous material are also described herein that include withdrawing lithium ions from the aqueous material by contacting the aqueous material with a withdrawal medium in a continuous cyclic process to load the withdrawal medium with lithium ions, contacting the loaded withdrawal medium with an aqueous eluent to unload lithium ions from the withdrawal medium, and monitoring loading and unloading of the withdrawal medium using nuclear magnetic resonance analysis. The methods can also include adjusting cycle time of the withdrawal medium, temperature of the aqueous material, temperature of the aqueous eluent, flow rate of the aqueous material, flow rate of the aqueous eluent, or volume of withdrawal medium in service, or any combination thereof, based on results of the nuclear magnetic resonance analysis of the withdrawal material.

While the foregoing is directed to embodiments of the present invention, other and further embodiments of the present disclosure may be devised without departing from the basic scope thereof, and the scope thereof is determined by the claims that follow.

1. A method, comprising:
using a withdrawal material to withdraw lithium ions from an aqueous material in a loading process;
using an eluent to remove lithium ions from the withdrawal material in an unloading process; and
using nuclear magnetic resonance to monitor performance of the withdrawal material during the loading process, the unloading process, or both.

2. The method of claim 1, wherein using nuclear magnetic resonance comprises obtaining a signal representing loading of withdrawn lithium ions in the withdrawal material, and further comprising determining an end point of the loading process based on the signal.

3. The method of claim 2, further comprising, upon reaching the end point of the loading process, discontinuing the loading process and beginning the unloading process by contacting the withdrawal material with an aqueous eluent.

4. The method of claim 2, further comprising determining an end point of the unloading process based on the signal and discontinuing the unloading process when the end point of the unloading process is reached.

5. The method of claim 4, wherein the end point of the loading process, the end point of the unloading process, or both, is determined based on an integrated area of the signal.

6. The method of claim 1, wherein using nuclear magnetic resonance to monitor performance of the withdrawal material during the loading process, the unloading process, or both, comprises:
exposing an unused withdrawal material to a standard lithium solution to yield a lithium-exposed withdrawal material test volume;
analyzing the lithium-exposed withdrawal material test volume using nuclear magnetic resonance to obtain one or more signals; and
determining a relation of the one or more signals to a quantity of lithium in the lithium-exposed withdrawal material test volume.

7. The method of claim 1, wherein the loading process is a counter current adsorption desorption process.

8. The method of claim 7, further comprising using nuclear magnetic resonance to obtain a plurality of signals representing loading of withdrawn lithium ions in a plurality of volumes of the withdrawal material.

9. The method of claim 1, further comprising:
during the loading process, the unloading process, or both, sampling the withdrawal material and obtaining a signal representing loading of withdrawn lithium ions in the sample by nuclear magnetic resonance; and
determining an end point of the loading process, the unloading process, or both based on the signal.

10. The method of claim 1, wherein using nuclear magnetic resonance to monitor performance of the withdrawal material comprises ascertaining a loading capacity of the withdrawal material, ascertaining a change in loading capacity of the withdrawal material, ascertaining an end point of the loading process, ascertaining an end point of the unloading process, ascertaining a regeneration point of the withdrawal material, ascertaining an exhaustion point of the withdrawal material, ascertaining a lithium loading gradient of the withdrawal material, ascertaining a lithium unloading gradient of the withdrawal material, and comparing the performance of a first withdrawal material with a second withdrawal material.

11. The method of claim 1, wherein using nuclear magnetic resonance to monitor performance of the withdrawal material comprises performing a plurality of nuclear magnetic resonance analyses of the withdrawal material at different times, different locations, or both.

12. The method of claim 1, wherein using nuclear magnetic resonance to monitor performance of the withdrawal material comprises determining a relation between a nuclear magnetic resonance signal and a lithium quantity in the withdrawal material by exposing an unused volume of the withdrawal material to a standard lithium solution to yield a lithium-exposed withdrawal material test volume and performing nuclear magnetic resonance analysis on the test volume.

13. The method of claim 1, further comprising adjusting a cycle time of the withdrawal material, temperature of the aqueous material, temperature of the eluent, flow rate of the aqueous material, flow rate of the eluent, volume of withdrawal material in service, or any combination thereof based on the nuclear magnetic resonance monitoring.

14. The method of claim 1, wherein each of the loading process and the unloading process is part of a counter current adsorption desorption process.

15. The method of claim 1, wherein the content of one or more elements of interest besides lithium is resolved using sequential nuclear magnetic resonance analyses.
